(19) United States
(12) Patent Application Publication
(10) Pub. No.: US 2019/0027872 A1
(43) Pub. Date: Jan. 24, 2019

(54) HIGH-SPEED ELECTRICAL CONNECTOR, SIGNAL MODULE THEREOF AND METHOD FOR FORMING SIGNAL MODULE

(71) Applicant: AVIC JONHON OPTRONIC TECHNOLOGY CO., LTD, Henan (CN)

(72) Inventors: Junfeng YUAN, Henan (CN); Dong LI, Henan (CN); Guoqi ZHOU, Henan (CN)

(73) Assignee: AVIC JONHON OPTRONIC TECHNOLOGY CO., LTD, Henan (CN)

(21) Appl. No.: 16/079,560

(22) PCT Filed: Mar. 21, 2017
(86) PCT No.: PCT/CN2017/077554

§ 371 Date: Aug. 24, 2018

(30) Foreign Application Priority Data
Jul. 29, 2016 (CN) 201610610611.7

(51) Int. Cl. H01R 13/6594; H01R 13/6585; H01R 13/405

(52) U.S. Cl. CPC H01R 13/6594; H01R 13/405; H01R 13/6585

(57) ABSTRACT

A high-speed electrical connector, comprising a signal module (1). The signal module comprises a contact (11). At least one side of the contact is provided with a shield piece (12). The signal module further comprises an insulator (13). The insulator is formed on the contact and the shield piece by means of injection moulding so as to combine the contact and the shield piece together. The insulator of the signal module of the electrical connector is encapsulated on the contact and the shield piece by means of injection moulding. Thus, the degree of stability of the signal module is enhanced, and the problem that a signal module of an existing high-speed electrical connector is easily deformed is solved.

### BACKGROUND OF THE INVENTION

### 1. Field of the Invention

The present invention relates to the field of connectors, in particular, to a high-speed electrical connector and a signal module thereof and a forming method of the signal module.

### 2. Description of Related Art

An existing high-speed electrical connector mainly consists of a shell, contact modules assembled in the shell in a stacking manner and shield pieces arranged between the contact modules, a signal module comprises the contact modules and the shield pieces arranged between the contact modules; for example, China Patent Application, entitled “Connector and Contact Module thereof and Forming Method of Contact Module” with the notification number of CN102437456B and the announcement date of Dec. 10, 2014, the connector comprises a front base plate and at least two stacked contact modules transferred to the front base plate; the contact module comprises a slice type insulator and a contact encapsulated in the insulator by means of injection moulding; the shield piece is arranged at one side of each contact module in a clamping manner; the shield pieces and the contact modules form the signal module of the connector; and during manufacturing, firstly, all contacts of the contact modules are located and put in the same injection mould in a matching manner, and then are encapsulated by means of injection moulding, and thus, the production efficiency of the contact modules is greatly increased, however, a shield module structure of clamping the shield pieces on the insulator has low degree of stability, and is easily deformed in an assembly process.

### SUMMARY OF THE INVENTION

The present invention is directed to a high-speed electrical connector so as to solve the problem that a signal module of an existing high-speed electrical connector is easily deformed; in addition, the present invention is also directed to a signal module used by the high-speed electrical connector and a forming method of the signal module.

In order to realize the objectives, the technical solution of the high-speed electrical connector of the present invention is as follows: the high-speed electrical connector comprises a signal module; the signal module comprises a contact; at least one side of the contact is provided with a shield piece; the signal module further comprises an insulator; and the insulator is formed on the contact and the shield piece by means of injection moulding so as to combine the contact and the shield piece together. The insulator of the signal module is formed on the contact and the shield piece by means of injection moulding, and thus, the degree of stability of the signal module is enhanced.

Further, the insulator comprises a contact insulator part encapsulated on the contact by means of injection moulding and a shield piece insulator part encapsulated on the shield piece by means of injection moulding; and the shield piece insulator part encapsulates the shield piece on the contact insulator part by means of injection moulding after encapsulating the contact insulator part by means of injection moulding. Thus, a support fixture in an injection mould is simplified, and meanwhile, the accurate relative position relationship between the shield piece and the contact can also be ensured.

Further, the contact comprises differential pairs and ground connection contacts arranged between the differential pairs; at least one of the ground connection contacts and the shield piece is provided with bulge structures being bulged toward the other one; and the ground connection contacts are electrically contacted with the shield piece by the corresponding bulge structures.

The technical solution of the signal module of the present invention is as follows: the signal module comprises a contact; at least one side of the contact is provided with a shield piece; the signal module further comprises an insulator; and the insulator is formed on the contact and the shield piece by means of injection moulding so as to combine the contact and the shield piece together.

Further, the insulator comprises a contact insulator part and a shield piece insulator part, the shield piece insulator part encapsulates the shield piece on the contact insulator part by means of injection moulding after encapsulating the contact insulator part by means of injection moulding.

Further, the contact comprises differential pairs and ground connection contacts arranged between the differential pairs; at least one of the ground connection contacts and the shield piece is provided with bulge structures being bulged toward the other one; and the ground connection contacts are electrically contacted with the shield piece by the corresponding bulge structures.

The technical solution of a forming method of the signal module of the present invention is as follows: the insulator of the signal module is formed on the contact and the shield piece by means of injection moulding so as to combine the contact and the shield piece together.

Further, injection molding of the insulator of the signal module comprises the following steps: (1) putting the contact in a corresponding mold, encapsulating on the contact by means of injection moulding, forming the contact insulator part on the encapsulated contact, and an insertion end of the contact being outside the contact insulator part; and (2) putting the encapsulated contact and the contact insulator part in the corresponding mold, then compressing the shield piece on the contact insulator part tightly, encapsulating on the shield piece by means of injection moulding, and forming the shield piece insulator part on the encapsulated shield piece, the shield piece insulator part and the contact insulator part forming the insulator of the signal module.

Further, a locating slot suitable for the shield piece is formed in the contact insulator part manufactured in step (1); and in step (2), the shield piece is pushed tightly in the locating slot, and then the shield piece is encapsulated by means of injection moulding.

Further, the contact the contact in step (1) comprises differential pairs and ground connection contacts arranged between the differential pairs; at least one of the ground connection contacts and the shield piece is provided with bulge structures being bulged toward the other one; the ground connection contacts are electrically contacted with the shield piece by the corresponding bulge structures; and avoidance holes for avoiding the bulge structures are formed on the contact insulator part manufactured in step (1).

The present invention has the beneficial effects that the signal module of the high-speed electrical connector comprises the insulator; the insulator is formed on the contact and the shield piece by means of injection moulding so as to combine the contact and the shield piece together, and thus, the fixation of the shield piece and the contact is realized; and compared with a signal module of an existing electrical connector, the signal module of the electrical connector of the present invention has the advantages that the insulator of the signal module of the electrical connector is encapsulated on the contact and the shield piece by means of injection moulding, thus, the degree of stability of the signal module is enhanced, and the problem that the signal module of the existing high-speed electrical connector is easily deformed is solved.

Further, the insulator comprises the contact insulator part encapsulated on the contact by means of injection moulding and the shield piece insulator part encapsulated on the shield piece by means of injection moulding; the shield piece insulator part encapsulates the shield piece on the contact insulator part by means of injection moulding after encapsulating the contact insulator part by means of injection moulding; and thus, the support fixture in the injection mould is simplified, and meanwhile, the accurate relative position relationship between the shield piece and the contact can also be ensured.

Further, the contact comprises differential pairs and ground connection contacts arranged between the differential pairs; at least one of the ground connection contacts and the shield piece is provided with bulge structures being bulged toward the other one; the ground connection contacts are electrically contacted with the shield piece by the corresponding bulge structures; and thus, the mutual interference between the adjacent differential pairs is completely avoided, the encapsulation by means of injection moulding can simplify the connection relationship between the ground connection contact and the shield piece, and meanwhile, can also ensure the good electrical connection between the ground connection contact and the shield piece.

### BRIEF DESCRIPTION OF THE DRAWINGS

FIG. 1 is a structural schematic diagram of a specific embodiment of a high-speed electrical connector of the present invention.

FIG. 2 is an explosive view of a signal module of the specific embodiment of the high-speed electrical connector of the present invention.

FIG. 3 is a sectional view of the signal module of the specific embodiment of the high-speed electrical connector of the present invention.

### DESCRIPTION OF THE EMBODIMENTS

The implementation mode of the present invention is further described with the accompanying drawings below.

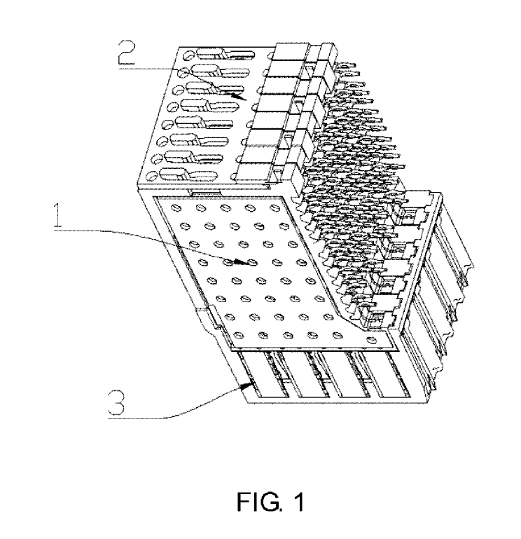

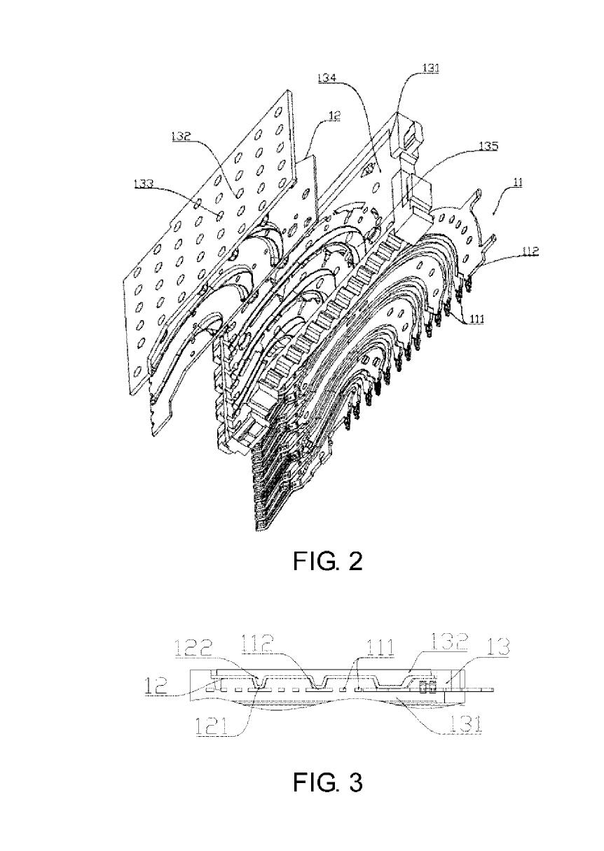

A specific embodiment of an electrical connector of the present invention is as shown in FIG. 1 to FIG. 3, the electrical connector comprises a signal module 1, a fixing plate 2 for fixing adjacent signal modules, and a shell 3 for installing the signal module, the signal module comprises a contact 11 and an insulator 13, one side of the contact is provided with a shield piece 12, in the present embodiment, the contact is of a layer structure, and the contact comprises differential pairs 111 and ground connection contacts 112, the differential pairs are clamped between the two ground connection contacts, the arrangement mode of the differential pairs and the ground connection contacts belongs to the prior art, and the descriptions thereof are omitted. The shield piece 12 is provided with bulge structures being bulged toward the ground connection contacts, the bulge structures are strip bulges 121 which extend in parallel with the differential pairs, grooves 122 sinking toward the bulge structures are formed in the backs, and the backs face backward to the bulge direction of the bulge structures, the ground connection contacts are electrically contacted with the shield piece by the corresponding bulge structures, and the adjacent differential pairs are isolated. The insulator 13 is encapsulated on the contact and the shield piece by means of injection moulding. In the present embodiment, the insulator 13 comprises a contact insulator part 131 encapsulated on the contact by means of injection moulding and a shield piece insulator part 132 encapsulated on the shield piece by means of injection moulding, the shield piece insulator part encapsulates the shield piece on the contact insulator part by means of injection moulding after encapsulating the contact insulator part by means of injection moulding. Technological holes 133 are formed in the shield piece insulator part 132, during injection moulding, push rods of an injection mold push the shield piece so as to compress the shield piece tightly on the contact insulator part; and after forming, the push rods quit, and the technological holes are formed.

A forming method of a specific signal module comprises the following steps: (1) putting the contact in a corresponding mold, encapsulating on the contact by means of injection moulding, forming the contact insulator part on the encapsulated contact, an insertion end of the contact being outside the contact insulator part, and forming a locating slot 134 with the shape suitable for the shape of the shield piece and avoidance holes 135 for avoiding the bulge structures on the contact insulator part; and (2) putting the encapsulated contact and the contact insulator part in the corresponding mold, then compressing the shield piece in the locating slot of the contact insulator part tightly, correspondingly inserting the bulge structures on the shield piece into the avoidance holes so as to ensure the electrical contact between the shield piece and the ground connection contacts, encapsulating on the shield piece by means of injection moulding, and forming the shield piece insulator part on the encapsulated shield piece, the shield piece insulator part and the contact insulator part forming the insulator of the signal module.

The difference between a specific embodiment 2 of a high-speed electrical connector of the present invention and the specific embodiment 1 of the foregoing high-speed electrical connector only lies in that the shield piece and the contact in the present embodiment 2 are put in a corresponding mould together and are encapsulated by means of injection moulding.

According to a specific embodiment of the signal module of the present invention, the signal module has the same structure as that of the signal module of the specific embodiment 1 or 2 of the foregoing high-speed electrical connector, and the descriptions thereof are omitted herein.

According to a special embodiment of a forming method of the signal module of the present invention, the forming method of the signal module comprises the same steps as that of the forming method of the signal module of the specific embodiment 1 or 2 of the high-speed quick electrical connector, and the descriptions thereof are omitted.

In other embodiments, the foregoing signal module can also be provided with two shield pieces, namely, two sides of the contact are both provided with the shield pieces; the bulge structures can also be omitted on the foregoing shield piece, a bulge structure being bulged toward one side of the shield piece is arranged on the ground connection contact; the ground connection contact can also be omitted on the signal module, and in this case, shielding is carried out only through the shield piece.

1. A high-speed electrical connector, comprising: a signal module, the signal module comprising a contact, and at least one side of the contact providing with a shield piece; wherein the signal module further comprises an insulator, and the insulator is formed on the contact and the shield piece by means of injection moulding so as to combine the contact and the shield piece together.

2. The high-speed electrical connector according to claim 1, wherein the insulator comprises a contact insulator part encapsulated on the contact by means of injection moulding, and a shield piece insulator part encapsulated on the shield piece by means of injection moulding, and the shield piece insulator part encapsulates the shield piece on the contact insulator part by means of injection moulding after encapsulating the contact insulator part by means of injection moulding.

3. The high-speed electrical connector according to claim 1, wherein the contact comprises differential pairs and ground connection contacts arranged between the differential pairs, at least one of the ground connection contact and the shield piece is provided with bulge structures being bulged toward the other one, and the ground connection contacts are electrically contacted with the shield piece by the corresponding bulge structures.

4. A signal module, comprising: a contact, at least one side of the contact providing with a shield piece; wherein the signal module further comprises an insulator, and the insulator is formed on the contact and the shield piece by means of injection moulding so as to combine the contact and the shield piece together.

5. The signal module according to claim 4, wherein the insulator comprises a contact insulator part and a shield piece insulator part, and the shield piece insulator part encapsulates the shield piece on the contact insulator part by means of injection moulding after encapsulating the contact insulator part by means of injection moulding.

6. The signal module according to claim 4, wherein the contact comprises differential pairs and ground connection contacts arranged between the differential pairs, at least one of the ground connection contacts and the shield piece is provided with bulge structures being bulged toward the other one, and the ground connection contacts are electrically contacted with the shield piece by the corresponding bulge structures.

7. A forming method of a signal module, wherein an insulator of the signal module is formed on a contact and a shield piece by means of injection moulding so as to combine the contact and the shield piece together.

8. The forming method of the signal module according to claim 7, wherein injection molding of the insulator of the signal module comprises the following steps: (1) putting the contact in a corresponding mold, carrying out injection moulding encapsulation on the contact, forming a contact insulator part on the encapsulated contact, and an insertion end of the contact being outside the contact insulator part; and (2) putting the encapsulated contact and the contact insulator part in the corresponding mold, then compressing the shield piece on the contact insulator part tightly, carrying out injection moulding encapsulation on the shield piece, and forming a shield piece insulator part on the encapsulated shield piece, the shield piece insulator part and the contact insulator part form the insulator of the signal module.

9. The forming method of the signal module according to claim 8, wherein a locating slot suitable for the shield piece is formed on the contact insulator part manufactured in step (1); and in step (2), the shield piece is pushed tightly in the locating slot, and then the shield piece is encapsulated by means of injection moulding.

10. The forming method of the signal module according to claim 8, wherein the contact in step (1) comprises differential pairs and ground connection contacts arranged between the differential pairs, at least one of the ground connection contact and the shield piece is provided with bulge structures being bulged toward the other one, the ground connection contacts are electrically contacted with the shield piece by the corresponding bulge structures, and avoidance holes for avoiding the bulge structures are formed on the contact insulator part manufactured in step (1).

11. The high-speed electrical connector according to claim 2, wherein the contact comprises differential pairs and ground connections contact arranged between the differential pairs, at least one of the ground connection contact and the shield piece is provided with bulge structures being bulged toward the other one, and the ground connection contacts are electrically contacted with the shield piece by the corresponding bulge structures.

12. The signal module according to claim 5, wherein the contact comprises differential pairs and ground connection contacts arranged between the differential pairs, at least one of the ground connection contact and the shield piece is provided with bulge structures being bulged toward the other one, and the ground connection contacts are electrically contacted with the shield piece by the corresponding bulge structures.

13. The forming method of the signal module according to claim 9, wherein the contact in step (1) comprises differential pairs and ground connection contacts arranged between the differential pairs, at least one of the ground connection contact and the shield piece is provided with bulge structures being bulged toward the other one, the ground connection contacts are electrically contacted with the shield piece by the corresponding bulge structures, and avoidance holes for avoiding the bulge structures are formed in the contact insulator part manufactured in step (1).
